(19) United States
(12) Patent Application Publication
(10) Pub. No.: US 2007/0196809 A1
(43) Pub. Date: Aug. 23, 2007

(54) Digital Reality Sports, Games Events and Activities in three dimensional and interactive space display environment and information processing medium

(75) Inventor: Prabir Sen, Glenview, IL (US)

Correspondence Address: PRABIR SETN, 18 WASHINGTON STREET, GLENVIEW, IL, 60025, US

(73) Assignee: Mr. Prabir Sen, Glenview, IL (US)

(21) Appl. No.: 11/307,772

(22) Filed: Feb. 21, 2006

(51) Int. Cl. G09B 25/00; A63F 9/24

(52) U.S. Cl. 434/365; 434/236; 463/9

(57) ABSTRACT

This invention relates to means for a real-life human performing certain specific activity—sports, games, events, education, shopping, defense activities, etc. where the person is interfacing with the computer generated three dimensional environment in which real-life human interacts with a sensory-immersing simulated environment that contains real-life experiences which interactively responds to and is controlled by the behavior of the real-life humans that give them more control over how the information is viewed. Technical problem to be solved by the present invention is to create a flexible system of rendering three-dimensional interactive environment to record and present behavioral strategy of a personality or team of persons a whole such that said system can be built into now-existing systems without their cardinal modification. An individual or team profile of a real-life performer's personality and matrix of interactivity model thereof are determined as “profile” information which can be performed either explicitly for the player before beginning the game, or in the course of the game, being unnoticed by the performer when the various simulated combinations are generated the computer components. Next instructions for the game or activity are generated taking account of the data. A imaginary (virtual) character (Kalpona) is created in the digital form in order to interact with the real-life performer which moves with motion sensor, sees the real-life person through digital camera and communicates through audio-visual apparatus or Personal Trigger Device (PDT). Thus, the entire course of the game is compared, from the very beginning of the game, with specific traits of performer's profile. Program items that characterize the interaction with Kalpona, objects and definite processes are compared with the results concerning some or other performers, objects or processes of the game, thus step-by-step playing back to the persons with the of a given particular player performance along with the comparison with other performers or record holders. In the course of the game itself, performer's actions are traced and compared with the corresponding aspects of the individual profile of the performer's personality and of the matrix of interactivity thereof. Games, events, and activities of the present type can be performed in three dimensional environment with interactive character using both individual PDT, radio frequency ID and using local or global telecommunication or computer networks of any type or kind.

This application is a continuation in part of U.S. patent application Ser. No. 10/709394, filed on 01 May. 2004

The traditional physical sports have very limited digital interfaces that create various situations and environments as it does in video or digital games. The video games do not have physical presence of the sports. The present invention is a new physical and digital rendition of the sports, games and events in three-dimension photo-realistic simulation and interactive environment. All the traditional physical sports, including but not limited to, running, jumping, pole vault, shooting, archery, swimming, cycling, gymnastics, skating, skiing, rock climbing and river rafting, etc. and some of the traditional games and activities including but not limited to crystal maze, treasure hunt, paint ball, laser tag, battery operated car race, quiz, chess etc. that are played as person (in flesh and blood) in simulated three-dimensional interactive environment. To be more specific, for example, a person or a set of persons (hereinafter individual or collectively referred as “physical object”) is playing running jumping and pole vaulting sports (hereinafter referred as “activities”) through triggers and response (hereinafter referred as “interactivity”) in an environment which gives a look of a ‘highway’ (hereinafter referred as “simulated three dimension environment”).

### BACKGROUND OF THE INVENTION

The present invention relates “Digital-Reality” which is a real-life human interfacing with the computer generated three dimensional environment in which real-life human interacts with a sensory-immersing simulated environment that contains real-life experiences which interactively responds to and is controlled by the behavior of the real-life humans that give them more control over how the information is viewed. This is in fact a reverse (opposite) of “Virtual Reality” which is an artificial environment created with computer hardware and software where a user wearing special gloves, earphones, goggles and/or full-body wiring to feeding sensory input to the user, the devices also monitor the user's actions to “enter” and “navigate” the “3-D world” portrayed as graphic images and change viewpoint and interact with object in that world as if “inside” that world. For example: two physical players (real-life) playing chess (digitally configured) on a flat screen in the form of a table in a three dimensional environment (digitally simulated on the screens instead of walls) which provides the visual rendition of the location, say an indoor hotel location in Paris.

“Digital-Reality” generally to systems and methods for using computer generated simulated three-dimensional environments to performance certain physical activities. The invention is useful in sports, games, retail display, defense, medical, psychotherapy, entertainment, and vocational training environments.

The present invention provides several advantages over the prior “Virtual Reality” by incorporating a “physical” component that adds specificity in terms of evaluating physical-virtual behavior relationships when performing an activity, and that assists in the selection of the appropriate strategy for any specific activity. Functional imaging is defined as the content data obtained by various imaging methods that are sensitive, directly or indirectly, to the activity. Known in the present state of the art is an improvement in computer games by adding physical means thereto. A software module is incorporated into an activity program, or said module may be loaded into computer memory separately. Said module discontinues the activity periodically, and an “inscribed trigger” is created and displayed on the monitor's screen, asking a question that must be answered or responded correctly as “physical response” so that the activity may be resumed. The activity is not resumed until a correct response is made. Questions may be asked at a level which adapt itself to the abilities selected by the player. When the player or set of players as a team (the “physical object”) is incapable of answering the question or responding any trigger within a predetermined lapse of time, a digital character (“Kalpona”) appears on the screen in the three dimension environment. If the physical object is still incapable of answering the question within a second predetermined lapse of time, the Kalpona answers and explanation are displayed on the screen as real-life experience, whereupon the physical object may resume the game having entered the answer. Hence the faster is the physical object able to respond to the trigger, faster is the physical object able to resume the activity from one module to another. The module may comprise security elements so as to prevent unauthorized deactivation thereof (cf. U.S. Pat. No. 6,024,572). The proposed apparatus is capable of teaching as well, but working out behavioral profile and strategy as a set of methods and motivating factors of a physical object in this particular case by mastering ready-to-use recommendations is a very difficult task because questions are asked and recommendations are given without making allowance for personal peculiarities of the physical object.

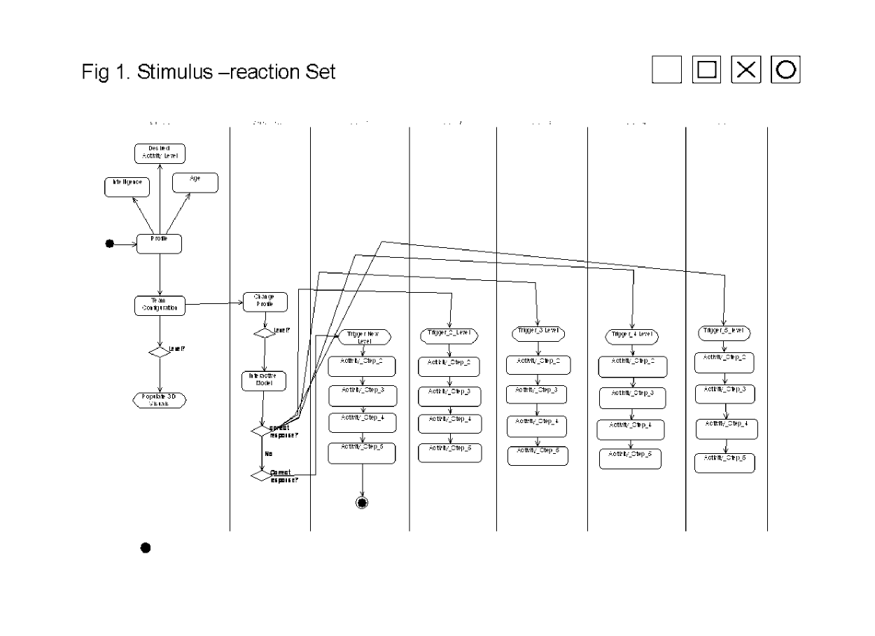

The closest real-life to the herein-proposed invention is a method for a person's (the “physical object”) sports, games and activity in a three dimensional computer generated environment with triggers-response ability, wherein an individual - physical and intelligence—profile (the “profile”) of a person and combinations of the “stimulus-reaction” variants (patterns established based on the physical object's response to emotional intelligence questions) hidden (“archived”) in the real-life experiences that are displayed in the screen with three-dimension projection system (cf US Pat No: 6,437,777). Testing is carried out by exposing the subject under test to the effect of various combinations of audio-visual, tactile, and other stimuli and determining his/her reaction thereto. In this case, a number of interactive parameters of the subject interacting with the system are assessed and recorded, using a variety of sensors connected to various locations and recorded in a computer. Once a map has been compiled of sets of reactions to some combinations of stimuli or other, a special set of artifacts are created by means of real-life environments and encoding some or other sets of reactions of a given particular subject is compared, using a definite procedure, to each of said map sets. Hence there is established a kind of a symbolic model of the “stimulus-reaction” sets (see FIG. 1) which model characterizes an individual physical and intelligence profile of a subject and the structure of the “stimulus-reaction” sets archived in the memory thereof. Once said model has been created, an action program aimed to establishing possible options, for a given particular subject, on dealing with Kalpona or other characters, and sequences thereof, as well as transformation of Kalpona sequences presented to him in the digital environment with a view to correcting the physical object's behavioral strategy and improving memory thereof. An “apparatus” or digital medium for data carrier, wherein game levels and physical intelligence information of the player (the “physical object”) has been recorded beforehand, wherein additionally recorded thereon is an analyzing and correcting module aimed at monitoring physical object's actions and comparing them with the corresponding aspects of an individual Olympic, National, International or World Record profile of physical object's personality and matrix of interactive model thereof, determining, just for the given particular physical object, the key points of the game which determine selecting some actions or other by the physical object so as to set a further course of the game, and generating instructions for writing physical object's actions and state of game at said key points of the game

It is necessary to point out that execution of behavioral strategy in the method under consideration is carried out by providing maximum possible effect on physical object's sensations and perception created by the means of real-life experience displayed in the screen as three-dimension rendition in combined audition-video-tactile images (hereinafter considered as “simulated environment”). This, on the hand, involves use of very complicated equipment and numerous auxiliaries whereby the system is sufficiently sophisticated and goal-oriented and configuration is available for widespread use. And, on the other hand, there occurs a large-scale invasion into physical-intelligence (for a limited time of activity duration) effected on the basis of a certain though rather complicated and optimized but fixed interaction model. Both indirect and delayed sequels of such effects may be unpredictable enough, whereby a long-term monitoring of those interaction parameters of human intelligence and memory which have been recorded.

The computer (Host A) stores three-dimensional image data for providing three-dimension photo-realistic displays on specially designed screen (hereinafter referred as PR displays) which renders visuals such as streets of New York, city of London or other locations, images and characters that creates an environment. These PR data for numerous situations, such as London road during winter, traffic jam, accident, earthquake, etc. are the core components, therefore, do not change. When the basic data are not subject to update. This system provides the PR images of buildings, roads and other items to create an simulated environment. The same computer also stores data related to various triggers and response to trigger as audio input.

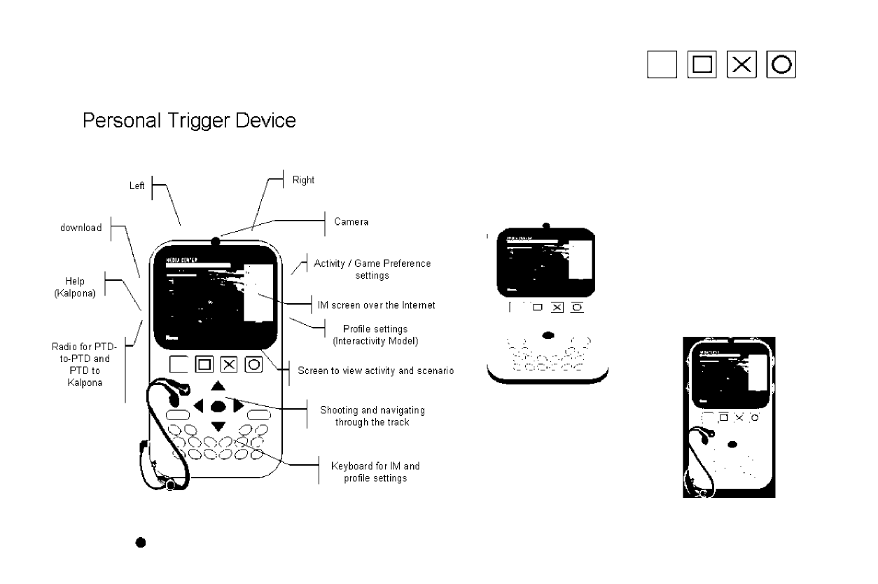

The virtual character (called “Kalpona”) in three dimension photo realistic environment is like a client terminal (Host A) which receive voice-activated information from the physical object (the Personal Trigger Device—the “PTD” see FIG. 2) and accordingly appears on the screen. The Kalpona answers and provides explanation are displayed on the screen as real-life experience, whereupon the physical object may resume the activity having entered the answer or response and the sensor data the physical movement based on camera movement of the physical object and synchronize them to provide the input to the other computer (Host B)

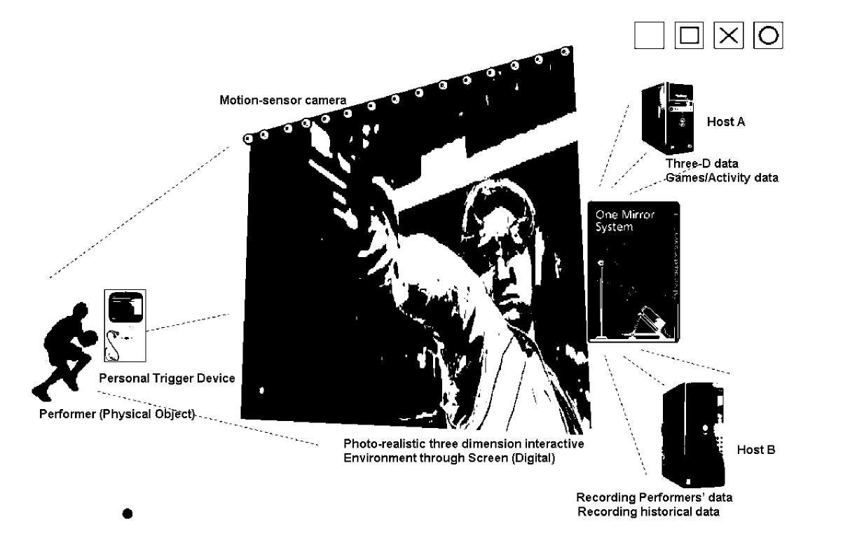

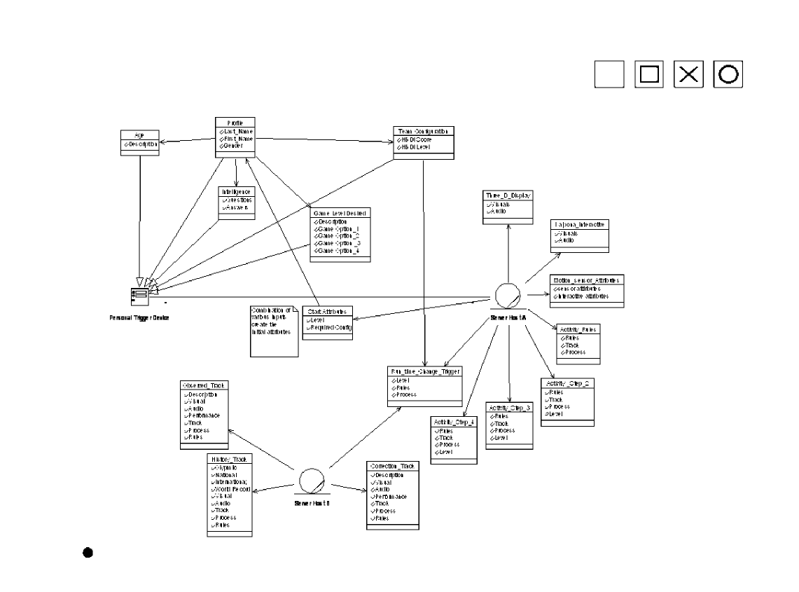

What follows, a procedure of communication between the physical object and ‘Kalpona’ are recorded and updated in the computer (Host B) which triggers Host A to display and/or generate audio output based on the information request from Host B (See FIG. 3 and 4). A predetermined display attribute can be attached to overlay message. if the attached display attribute is for specifying scrolling or moving (synchronized with physical object movement) the overlay message is displayed in a scrolled manner (giving an impression of movement). If the display attribute is for specifying reverse display, flashing , coloring, or display sizing, the overlay message is displayed as specified.

All major motions are monitored, recorded and processed by the PC in real-time. One known motion tracking system is called Motion Star wireless from Ascension Technologies. It is a wireless solution that can read up to 20 sensors in real-time. This kind of tracking is known as 6DOF (Six Degrees of Freedom) tracker. This allows the major movements of the human to be monitored by the system and the information to be processed and applied to the virtual character—“Kalpona.”

To generate data for the three-dimension photo-realistic virtual reality medium, images are recorded using cameras positioned to cover the events from all sides. As used herein, images could be discreet objects, environments, objects interacting with an environment. Each camera produces a series of images with each image being comprised of a plurality of pixels. The depth information is further manipulated to produce object-centered descriptions of everything within an image. We develop the stand-alone system to synchronously record frames from multiple cameras. The output of each camera is time stamped with a common Vertical Interval Time Code (VITC). The time code allow us to correlate the frames across cameras which is crucial when transcribing movements and triggering effect through Host A.

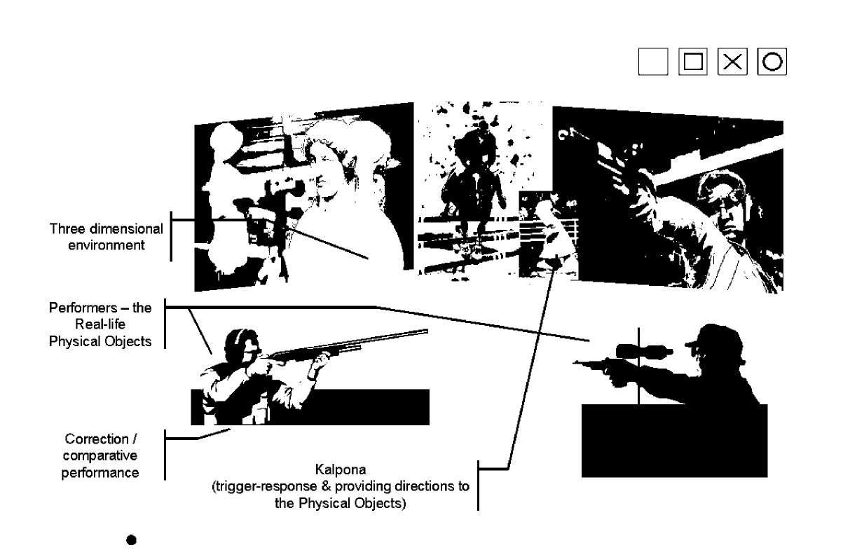

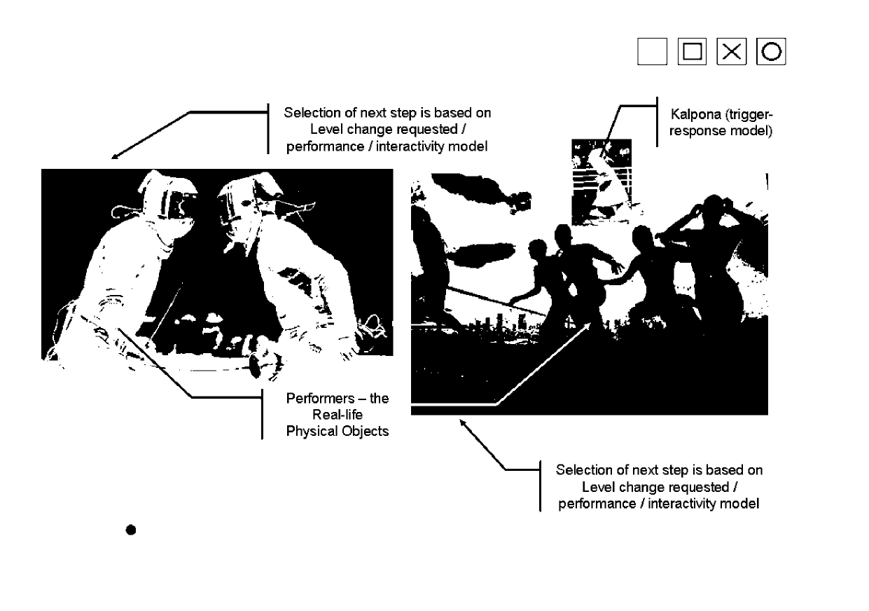

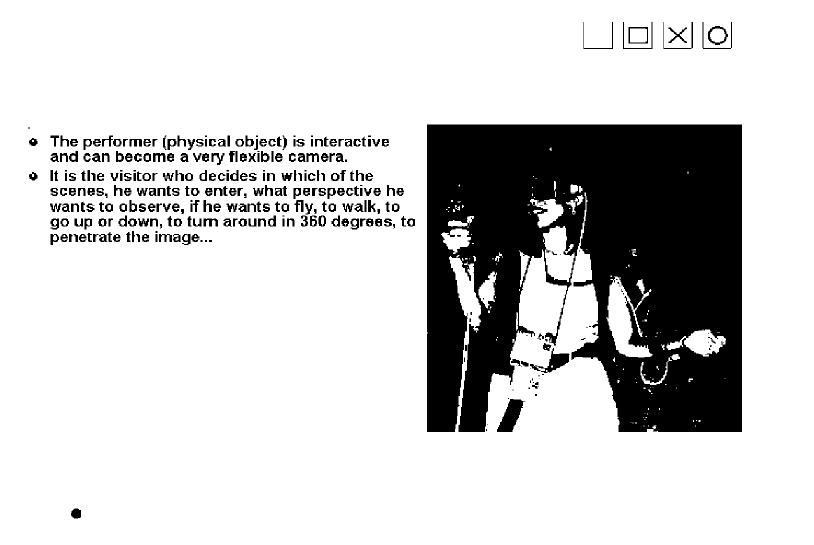

The method as claimed in any one of claims 1, 2, 3, and 4, characterized in that in the case of a number of games, events and activities (the “activities”) thereof there are determined what combinations of components of individual physical and intelligence (the “profile”) of physical object's personality and are inconsistent with successful individual's activity in the sphere of human activities simulated by the activities associated therewith, whereupon the appropriate conclusions and recommendations are presented. An apparatus for working out player's behavioral strategy using cognitive three-dimensional environment (the “environment”) comprises a data carrier whereon there is recorded software for activities. Physical object's testing means for determining individual profile of his/her personality and matrix of trigger-response (the “interactivity”) thereof. A means for generating instructions for the activity, a means for monitoring physical object's actions with respect to the activity characters or any digital objects and comparing said actions with the definite aspects of the individual profile of the physical object's personality and matrix of interactivity thereof. A means for identifying personal qualities or combinations thereof yielding one result or another. And, a means for establishing appropriate messages regarding player's profile state and recommendations on correcting his/her behavioral strategy at key points of the activity or, against physical object's request, at any other activity instants and issuing appropriate messages to the player with or without interrupting the activity, using appropriate linguistic formulas and audio-visual aids built-in for issuing messages, without interrupting the activity, to scenarios, topics, actions of characters, objects, graphic, audio and any other game components. The analyzing and correcting module is recorded on said data carrier or additional record carrier, said module being aimed at comparing and correlating the appropriate properties and parameters of individual profile of physical object's personality and matrix of event reaction thereof with the activity characters (the “kalpona”), objects and components in order to create a kalpona of the activity by imparting to said character or a group of characters the traits of individual profile of physical object's personality and matrix of interactivity thereof, as well as those of the actvity objects and processes with due account of the above said traits, said module further comprising said means for monitoring physical object's actions with regard to the kalpona or any objects thereof and comparing these with the aspects of individual profile of physical object's personality and matrix of interactivity thereof (See FIG. 5). The processis identifying personal qualities or combinations thereof resulting in selecting by the physical object some actions or other dictating one activity course or another, creating, on the PTD carrier, appropriate messages and recommendations on correcting player's behavioral strategy, as well as a means for determining those activity points which are key ones for a given particular physical object after which further activity parameters and/or scenarios, ways of its organization, representation and interaction of activity characters and objects, as well as means for activity realization comprising graphic, audio and other components thereof, are determined depending on physical object's behavioral strategy displayed to him/her with regard to kalpona or other objects of the behavioral strategy depending on properties and parameters of physical object's profile and matrix of interactivity thereof. The process is generating instructions for recording physical object's actions and state of activity at both said key points of the activity and those arbitrarily selected by the physical object; the apparatus further comprises a storage means for recorded player's actions and state of activity, while said means for identifying physical object's personal qualities or combinations thereof yielding an appropriate result, is capable of identifying said qualities or combinations thereof at any instant arbitrarily selected by the physical object and at key points of the activity determined automatically by said analyzing and correcting module by comparing and correlating definite properties and parameters of an individual profile of physical object's personality and matrix of interactivity thereof with both his/her actions regarding kalpona and objects, and methods for organization, representation and interaction of the kalpona or objects, as well as a means for activity realization, including graphic, audio and any other components and activity parameters and/or scenarios both in the course playing the activity and during its subsequent analysis (See FIG. 6). The apparatus of the present invention may be provided with a means for registering physical object's actions and state of activity at any point of the game selected by the physical object, and the analyzing module recorded on the computer may comprise means for determining new activity conditions not replicating the precedent ones for replaying an activity or the activity as a whole but with new profile guidelines, and means for determining those combinations of the components of an individual profile of physical object's personality and matrix of interactivity thereof which are inconsistent with successful individual's activity (See FIG. 7) in the sphere of human activities simulated by the kalpona.

The apparatus, methods and process of the present invention comprises:
(1) data server configuration
(2) whereon an integrated software
(3) for interactive three-dimensional simulated environment is recorded;
(4) a method for testing a physical object for determining an individual profile of physical object's personality and a matrix of interactivity thereof;
(5) a means for generating instructions for playing the activity;
(6) a means for monitoring physical object's actions and comparing them with the corresponding aspects of the Olympic, National, International or World Record of individual profile of the physical object's personality and of the matrix of interactivity thereof;
(7) a means for accessing and downloading combinations of the components of an individual profile of physical object personality and matrix of interactivity thereof, said combinations yielding one result or another; and
(8) a means for creating the appropriate messages and recommendations on correcting physical object's behavioral strategy.

The Apparatus Further Comprises
(1) a means for imparting to the digital characters (the “Kalpona”) that appears on the screen in the environment based on the traits of an individual profile of physical object's personality and of the matrix of interactivity thereof, said means, together with said means (6) for monitoring player's actions and comparing them with the corresponding aspects of the individual profile of the physical object's personality and of the matrix of interactivity thereof, said means (6) for identifying combinations of the components of an individual profile of the physical object's personality and matrix of interactivity thereof, and said means (7) for creating the appropriate messages and recommendations on correcting physical object's behavioral strategy on said computer server, is essentially an analyzing and correcting module (9) additionally recorded on the data server configuration (1), said module 9 further comprising
(2) a means for determining those key points of the activity which dictate selecting, by the physical object, some actions or other setting further course of the activity, and generating instructions for recording physical object's actions and state of the activity at said key points thereof.
(3) a means for storing the recorded physical object's actions and state of the activity, said means (11) being connected to a respective
(4) means for recording physical object's actions. Physical object's actions and state of the activity may be recorded at any activity point pre-selected by the physical object.

Hence when managing and playing game event or activity (the “activities”) of the aforementioned type, physical objects in reality performs activity based on his pre-recorded profile and interactivity model recorded in PDT and physical object's behavioral strategies recorded during the course of activity are compared with those which the physical object uses or could use in real life experience which is triggered or corrected through Kalpona. As a result, there are issued recommendations on what more efficient behavioral strategies exist.

### LIST OF FIGURES

(1) Profile and game configuration input and stimulus-response Interactivity matrix model
(2) The interactive device that performers carry as Personal Trigger device (PDT)
(3) The configuration of between physical object and interactive three-dimensional simulated environment
(4) The sample data configuration between PDT and Host A and Host B
(5) The interactivity between the physical objects and three-dimensional simulated environment with (imaginary character) kalpona determining the matrix model and next step in the game
(6) The next step in the game based on profile and matrix of interactivity model
(7) The performer with PDT and 3D glasses performing the activity

What is claimed is:

1. “Digital-Reality” is a real-life human interfacing with the computer generated three dimensional environment in which real-life human interacts with a sensory-immersing simulated environment that contains real-life experiences which interactively responds to and is controlled by the behavior of the real-life humans that give them more control over how the information is viewed, while “Virtual Reality” is an artificial environment created with computer hardware and software where a user wearing special gloves, earphones, goggles and/or full-body wiring to feeding sensory input to the user, the devices also monitor the user's actions to “enter” and “navigate” the “3-D world” portrayed as graphic images and change viewpoint and interact with object in that world as if “inside” that world. For example: two physical players (reality) playing computer chess (digital) in a three dimensional environment (digital) which provides the visual rendition of the location, say an indoor hotel location in Paris.

2. An “apparatus” or digital medium for data carrier, wherein game or activity levels, physical and intelligence (the “profile”) information of the player (the “physical object”) has been recorded beforehand, wherein additionally recorded thereon is an analyzing and correcting module aimed at monitoring the physical object's actions (the “actions”) and comparing them with the corresponding aspects of an individual Olympic, national international or World record profile of physical object's personality and matrix of interactivity model thereof, determining, just for the given particular physical object, the key points of the game which determine selecting some actions or other by the physical object so as to set a further course of the game, and generating instructions for writing physical object's actions and state of game at said key points of the activity.

3. An “apparatus” or digital medium as claimed in claim 2, wherein there is carried out a retrospective step-by-step analysis of physical object's actions, that are determined physical object's actions that would be optimal at said activity key points, and there are found the combinations of components of individual physical-intelligence profile of physical object's personality and the physical object's possibility of event reaction thereof, which combinations have been to a maximum extent responsive for a non-optimal choice made by the physical object.

4. A method as claimed in claim 2, of integrating the information that has been recorded beforehand by the physical object and processed for the next step in the activity based on the profile and actions of the physical object.

5. A method as claimed in claim 2, of integrating the information recorded, retrieved and accessed related to historical data of Olympic, national, international and world records profile in order to provide comparative information of the physical object in the apparatus claimed in claim 2.

6. A method as claimed in claim 2, of providing the information recorded, retrieved and accessed related to historical data of Olympic, national, international and world records profile in as a comparative information of the physical object in the apparatus claimed in claim 2.

7. A method as claimed in claim 3 carried out a retrospective step-by-step analysis of player's (the “physical object”) actions, there are determined physical object's actions that would be optimal at said activity key points, and there are found the combinations of components of individual physical-intelligence profile of physical object's personality and the physical object's possibility of event reaction thereof, which combinations have been to a maximum extent responsive for a non-optimal choice made by the physical object.

8. An “apparatus” or digital medium as claimed in claim 2, wherein in the case of a number of games and activities thereof are determined what combinations of interactivity models of individual physical and intelligence profile of player's (the “physical object”) personality and of matrix of activity “trigger-reaction” (interactivity) thereof are inconsistent with successful individual's activity in the sphere of human activities simulated by the game or activity that are immediately recorded and accessed by the physical object whereupon the appropriate conclusions and recommendations are presented as a next step in the activity.

9. A method as claimed in claim 8, in the apparatus in claim 2, of integrating the information games and activities thereof that are processed and determined what combinations of interactivity models of individual physical and intelligence profile of player's (the “physical object”) personality and of matrix of activity “trigger-reaction” (interactivity) thereof are consistent or inconsistent with successful individual's activity in the sphere of activities simulated by the game or activity that are immediately recorded and accessed by the physical object whereupon the appropriate conclusions and recommendations are presented as a next step in the activity.

10. An “apparatus” or digital medium or method recording physical object's behavioral strategy as a profile using cognitive simulated environment, comprising a data whereon there is recorded software for computer activities; means for physical object's testing effected either explicitly for the physical object before beginning the activity, or in the course of the game, being unnoticed by the physical object when the tests are the activity components, aimed at determining individual physical and intelligence profile of the physical objects's personality and matrix of interactivity model thereof; as means for generating instructions for the activity; means for monitoring physical object's actions with respect to the activity or any digital objects in the environment and comparing said actions with the definite aspects of the individual physical-intelligence profile of the physical-intelligence personality and matrix interactivity model thereof; means for identifying personal qualities or combinations thereof yielding one result or another; and means for establishing appropriate messages regarding the physical object's physical intelligence state and correcting the physical object's behavioral strategy at key points of the activity or, against the physical object's request, at any other activity instants and issuing appropriate messages to the physical object through digital images and characters (Kalpona) with or without interrupting the game or activity, using appropriate linguistic formulas and visual aids built-in for issuing messages, without interrupting the activity, to scenarios, topics, actions of characters, objects, graphic, audio and any other activity components, wherein an analyzing and correcting module is recorded on computer and said module being aimed at comparing and correlating the appropriate properties and parameters of individual physical-intelligence profile of physical object's personality and matrix of interactivity model thereof with the digital images and characters (Kalpona) objects and components in order to create a character or a group of characters of the activity by imparting to said character or a group of characters the traits of individual physical-intelligence profile of physical object's personality and matrix of interactivity model thereof, as well as those of the activity objects and processes, ways of its organization, representation and interaction of activity characters and objects, as well as means for activity realization comprising graphic, audio and other components thereof, are determined depending on physical object's behavioral strategy displayed by the physical object with regard to characters or other objects of the behavioral strategy depending on properties and parameters of physical object's physical-intelligence profile and matrix of interactivity model thereof, generating instructions for recording physical object's actions and state of activity at both said key points of the activity and those arbitrarily selected by the physical object; the apparatus further comprises a storage means for recorded physical object's actions, transition path and state of activity, while said means for identifying physical object's personal qualities or combinations thereof yielding an appropriate result, is capable of identifying said qualities or combinations thereof at any instant arbitrarily selected by the physical object and at key points of the activity determined automatically by said analyzing and correcting module by comparing and correlating definite properties and parameters of an individual physical intelligence profile of physical object's personality and matrix of interactivity model thereof with both the physical object's actions regarding activity.

11. An “apparatus” or digital medium as claimed in claim 10, wherein it is provided with a means for recording the physical object's actions and the state of activity at any point of the activity selected by the physical object.

12. A method as claimed in claim 10, of integrating what it is provided with a means for recording the physical object's actions and the state of activity at any point of the activity selected by the physical object.

13. An “apparatus” or digital medium as claimed in claim 10 wherein the apparatus claimed in claim 2 can be attached to download and access all the information of the physical object including retrospective step-by-step analysis of the physical object as claimed in the claim 3.

14. A method as claimed in claim 13 the way the apparatus claimed in claim 2 can be attached to download and access all the information of the physical object including retrospective step-by-step analysis of the physical object as claimed in the claim 3.

15. The method of claim 9 the way the apparatus claimed in claim 8, wherein said analyzing and correcting module comprises means for generating new activity conditions not replicating the precedent ones for replaying an activity event or the game as a whole but with new physical and intelligence (the “profile”) information guidelines based on actions.

16. The computer codes and logic of claim 15, wherein said analyzing and correcting module comprises means for determining those combinations of the components of individual physical and intelligent (the “profile”) of the physical object's personality and of matrix of interactivity model thereof which are inconsistent with successful individual's activity in the sphere of activities simulated by the activity and actions thereof or immediately associated therewith.

17. An “apparatus” or digital medium as claimed in claim 5 wherein the apparatus claimed in claim 2 attached or swiped for the information in order to enter or exit of the physical object in the activity area.

18. A method as claimed in claim 14 wherein the apparatus claimed in claim 2 attached or swiped for the physical object information for the entry or exit of in the activity area.

19. An “apparatus” or digital medium as claimed in claim 5 wherein the apparatus claimed in claim 2 displayed visually as information to the physical object that is applicable for the activity in the activity area.

20. An “apparatus” or digital medium as claimed in claim 5 wherein the apparatus claimed in claim 2 provides audio trigger or information as information to the physical object that is applicable for the activity in the activity area.

21. A method as claimed in claim 19 wherein the apparatus claimed in claim 2 display visual information to the physical object that is applicable for the activity in the activity area.

22. A method as claimed in claim 20 wherein the apparatus claimed in claim 2 provides audio trigger or information as information to the physical object that is applicable for the activity in the activity area.

23. An “apparatus” or digital medium as claimed in claim 5 wherein the apparatus claimed in claim 2 provides security information as information to the physical object that is applicable for the activity in the activity area.

24. A method as claimed in claim 20 wherein the apparatus claimed in claim 2 wherein the apparatus claimed in claim 2 provides security information as information to the physical object that is applicable for the activity in the activity area.
